(19) United States
(12) Patent Application Publication
(10) Pub. No.: US 2009/0286515 A1
(43) Pub. Date: Nov. 19, 2009

(54) MESSAGING SYSTEMS AND METHODS

(75) Inventor: Konstantin Othmer, Mountain View, CA (US)

Correspondence Address: Workman Nydegger;1000 Eagle Gate Tower, 60 East South Temple, Salt Lake City, UT, 84111, US

(73) Assignee: CORE MOBILITY, INC., Mountain View, CA (US)

(21) Appl. No.: 12/435,766

(22) Filed: May 5, 2009

Related U.S. Application Data
(63) Continuation-in-part of application No. 12/046,285, filed on Mar. 11, 2008, now Pat. No. 7,546,116.
Application No. 12/046,285 is a continuation of application No. 11/129,126, filed on May 13, 2005, now Pat. No. 7,363,029.
Application No. 11/129,126 is a continuation-in-part of application No. 11/007,700, filed on Dec. 8, 2004, now Pat. No. 7,317,929.
Application No. 11/007,700 is a continuation-in-part of application No. 10/661,033, filed on Sep. 12, 2003, now Pat. No. 7,133,687.

(51) Int. Cl. H04M 11/10

(52) U.S. Cl. 455/413

(57) ABSTRACT

A unified messaging interface and associated methods may enable mobile communication device users to initiate the creation of a message for a recipient without being required to explicitly specify the type of message that is to be created. The mobile communication device supports multiple message types, such as audio, text/SMS, picture and video messages. The user begins providing message content to the communication device by, for example, speaking, entering text, clicking a shutter of a camera or initiating the recording of video. The unified messaging interface detects the nature of the content and automatically creates a corresponding message type. Alternately, the device may create a reply message type depending on the reply address of the original message, and may transcribe the audio to text if the original message uses a text format. The one-click action is an operation performed on the device that can be instantiated as a single button-press on the keypad; selection of a single soft key by depressing a button on the keypad or touching the screen of the device; or issuance of a single voice command.

### CROSS-REFERENCE TO RELATED APPLICATIONS

This application is a continuation-in-part of U.S. patent application Ser. No. 12/046,285, filed Mar. 11, 2008; which is a continuation of U.S. patent application Ser. No. 11/129,126, filed May 13, 2005 U.S. Pat. No. 7,363,029); which is a continuation-in-part of U.S. patent application Ser. No. 11/007,700, filed Dec. 8, 2004 (now U.S. Pat. No. 7,317,929); which is a continuation-in-part of U.S. patent application Ser. No. 10/661,033, filed Sep. 12, 2003 (now U.S. Pat. No. 7,133,687). The foregoing patent applications are incorporated herein by reference.

### BACKGROUND

1. Field of the Invention

The present invention generally relates to messaging systems and methods.

2. Background Technology

The popularity of all types of communication devices, such as mobile telephones and telephony-enabled personal digital assistants (PDAs) is undeniable. In addition to circuit-switched and packet-switched voice sessions, numerous messaging applications, such as Email, Short Message Service (SMS) messages, Multimedia Messaging Service (MMS) messages, and Instant Messaging (IM) are available today on a wide variety of mobile communication devices. Also, services that assist users with information and updates, such as stock quotes, news alerts and driving directions, or services that improve personal productivity or provide customer services, can all be accessed and engaged via mobile communication devices. Furthermore, applications and services that deliver media content or other types of entertainment and are accessible via mobile communication devices are increasingly popular.

While applications and services that can be accessed via a mobile device deliver significant value to users, enhanced messaging services and the large modality of different ways of communicating (picture messaging, voice messaging, text messaging and video messaging) have made these devices more complicated, inhibiting their use. It is well known in the art of user interface design that each additional step required for a user to reach an objective diminishes the chance the user will complete the task.

Mobile phones started out as very simple devices from a usability standpoint. The user merely entered the number and pushed the TALK key—an experience familiar to almost everyone. With the advent of SMS Messaging, the user could leave a text message for another user with a mobile phone. This additional option of authoring and sending a text message is now well understood and widely adopted in the mobile phone industry. Over the past few years, additional services have been introduced to allow users to author audio messages, picture messages or video messages and exchange them with other users. These technologies are seeing broader adoption, but the interface for selecting between messaging technologies is now much more complicated, which restricts their use.

To allow the user to choose between these various options, the communications devices have become much more complicated. Instead of simply selecting a recipient and selecting “message” rather than “talk”, the user must now select what kind of message is to be sent: a text, audio, picture or video message. This is typically done from a menu, since devices do not have dedicated keys for these operations. This has increased the complexity of messaging from one key press to two or more, a 100% or more increase in complexity. In many situations, and for frequent users who desire “rapid-fire” communications, this extra key-press inhibits use.

These new technologies have introduced the richness of communicating through a wide variety of means at the expense of simplicity.

### SUMMARY

The present invention generally relates to messaging systems and methods.

In one aspect, the message sender chooses a recipient from a contacts list, and then selects a “Send Message” key. The device then presents an interface that allows the user to start recording to author an audio message or video message, start typing to author a text message, press the camera shutter button to author a picture message. If the user takes no action, an audio message is recorded. If the user types in text characters, a text message is authored, and if the user clicks the shutter, a picture message is created. The delivery of the resulting messages is performed as soon as the “SEND” key is pressed.

Thus, this aspect permits users to easily create text messages, record and transmit instant voice messages and video messages, or take and send a picture all from the same user interface to any recipient with just “one-click” on a mobile device.

The “one-click” action to launch the unified user interface can be physically performed on the device, such as a single button-press on the keypad of the mobile device, selection of a single soft key by using a button on the keypad, or by touching the screen of the device, or it can take the form of an articulated command.

For purposes of summarizing, some aspects, advantages and features of a few of the embodiments of the invention have been described in this summary. Some embodiments of the invention may include some or all of these summarized aspects, advantages and features. However, not necessarily all of (or any of) these summarized aspects, advantages or features will be embodied in any particular embodiment of the invention. Thus, none of these summarized aspects, advantages and features are essential. Some of these summarized aspects, advantages and features and other aspects, advantages and features may become more fully apparent from the following detailed description and the appended claims.

### BRIEF DESCRIPTION OF THE DRAWINGS

In order that the manner in which the advantages and features of the invention are obtained, a particular description of the invention will be rendered by reference to specific embodiments thereof which are illustrated in the appended drawings. Understanding that these drawings depict only typical embodiments of the invention and are not, therefore intended to be considered limiting of its scope, the invention will be described and explained with additional specificity and detail through the use of the accompanying drawings in which:

FIG. 1 is a block diagram illustrating a wireless network.

FIG. 2-4 are sample screens illustrating how the user interface of the unified messaging interface can appear. FIG. 2 shows the selection of a recipient. FIG. 3 shows the unified authoring interface including voice and text. FIG. 4 shows the screen that is displayed when the user starts typing on the keyboard to enter text.

FIG. 5 is a flow chart illustrating a method according to one embodiment of the invention by which a unified authoring interface permits a sender to create an audio message, a voice message, a video message, a text message, or a picture message.

### DETAILED DESCRIPTION OF THE PREFERRED EMBODIMENTS

Embodiments of the present invention are generally related to messaging systems and methods.

### I. Operating Environments Within Wireless Communication Systems

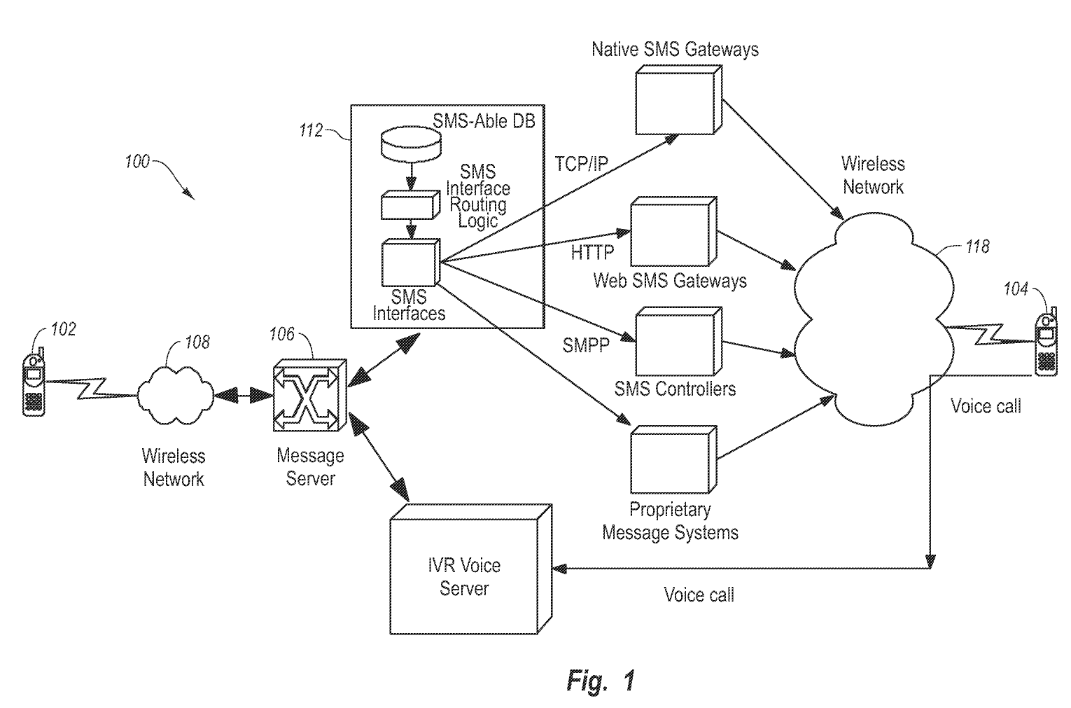

FIG. 1 is a block diagram illustrating an example of a wireless communication system in which the invention can be practiced. Wireless communication system 100 includes a sender device 102 that is used to create and transmit a message that is addressed to a recipient wireless station 104. Sender device 102 can be a wireless or mobile telephone, a conventional wired telephone, or any other telephony device. In general, sender device 102 can be any device that is capable of receiving and capturing audio data that forms the body of the voice message and addressing information that identifies the recipient or the recipient wireless station 104 associated with the recipient. Instead of being a dedicated telephony device, sender device 102 can also be a personal computer or other computing devices having the foregoing capabilities.

In the embodiment of FIG. 1, sender device 102 communicates with a message server 106 using wireless network 108. In general, however, sender device 102 can communicate with message server 106 using any suitable communication network or mechanism, another example of which is the Public Switched Telephone Network (PSTN). Message server 106 is a computer system that routes the message and performs the other operations described herein. It should be understood that the invention can be implemented in many types of network environments and various network architectures are applicable. In one embodiment, the message server 106 and the associated SMS blade 112 reside in a wireless operator's network infrastructure. In another embodiment, the message server 106 and the SMS blade 112 reside outside the domain of a wireless operator's infrastructure, and may be hosted, for example, by an independent hosting entity, such as an application service provider. Alternately, the message server 106 and the associated SMS blade 112 can reside behind a corporate firewall.

Additional details of the wireless communication system 100 of FIG. 1 are included in U.S. Pat. No. 7,317,929, which is incorporated herein by reference. Although the wireless communication system 100 of FIG. 1 provide a suitable operating environment for the use of unified messaging interfaces and associated methods of the invention, the invention can also be practiced in a variety of other wireless communication systems that support the creation and transmission of different types of electronic messages.

### II. Unified Messaging Interface

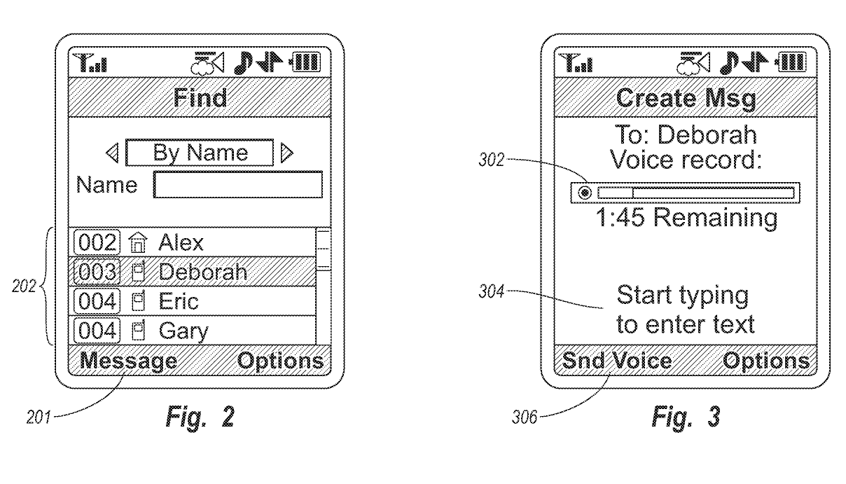

Now described in reference to FIGS. 2 through 4 is an example of the methods of the invention by which a message is authored using the Unified Messaging Interface. In FIG. 2, a sender selects the “Message” soft key 201 from the contact list 202 of a Sender Device. According to the invention, the service request to author a message can be created at the Sender Device 102 using any of a variety of possible “one-click”-enabled user interfaces and procedures. In this example, the interface of the wireless service installed on the device employs a method whereby the sender issues a spoken “single voice-command,” in lieu of a single click of a soft key, a button, or a key on a keypad, to execute the request. The term “one-click”, as used herein, extends to any user input operation or event that requires only a single action from the user, and is not limited to clicking a button. The single voice command and pressing a single button or key once on a keypad, and pressing a soft key once, are non-limiting examples of a “one-click” action.

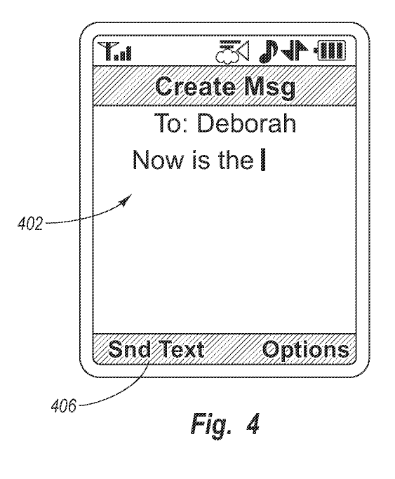

In FIG. 3, in response to the Unified Messaging Interface invocation, Sender Device 102 transitions to a mode in which it assists the sender in the process of composing the message. Immediately the device begins recording audio with the assumption that the user wants to send a voice message as shown by element 302 of the interface. As prompted by element 304 of the interface, the user can start typing at any time, to author an SMS text message rather than a voice message. In this case, the voice recording is discarded and the screen 402 in FIG. 4 is displayed, allowing the user to view the SMS message as the user inputs text. At any time in FIG. 3 or FIG. 4, the user can press the “Send Voice” soft key 306 or “Send Text” soft key 406, and the message will be delivered to the recipient previously selected. The Sending Device then submits the request to the wireless service, which can be carried out using conventional methods.

In the foregoing manner, voice or text messages can be quickly authored with a unified authoring interface with “one-click” access on a sender device. Alternately, the Unified Messaging Interface can provide a single interface for composing and sending a picture message in addition to voice and text messages. In particular, the option of creating and sending a picture message can be provided by the Unified Messaging Interface with a key that initiates that mode. In general, the principles of the invention, which include detecting the action of the user as the process of creating a message is initiated, can be extended to substantially any combination of two or more different types of messages, including those that exist now (e.g., text, audio, picture, video) and those that will be developed in the future.

### III. Examples of Use of Unified Messaging Interface

While embodiments of the invention are described in detail herein, the invention can be further illustrated by presenting specific examples of the efficiency gained using the methods of the Unified Authoring Environment. It is noted that the following example is presented only to illustrate the invention, and the specific implementation described hereinafter does not limit the scope of the invention.

According to a first example, the user selects the recipient from her mobile phone contact list, and clicks on a soft key to invoke the Unified Authoring Interface. She begins to speak her message and when done, presses the “send” key. Alternatively the user could continue to hold the key down while speaking, and upon letting go of the key, the message is sent. This removes another user action from the system, further simplifying the interface. Using this technique, the user has authored an audio message with one click (if the button is depressed while speaking) or two clicks (one to begin, and one to end/send). Similarly, if the user prefers to send a text message using the 12-button keyboard of her mobile phone, then after invoking the Unified Authoring Interface, she starts to “triple-tap” on the keyboard to create the message. When she is done, she presses the send key.

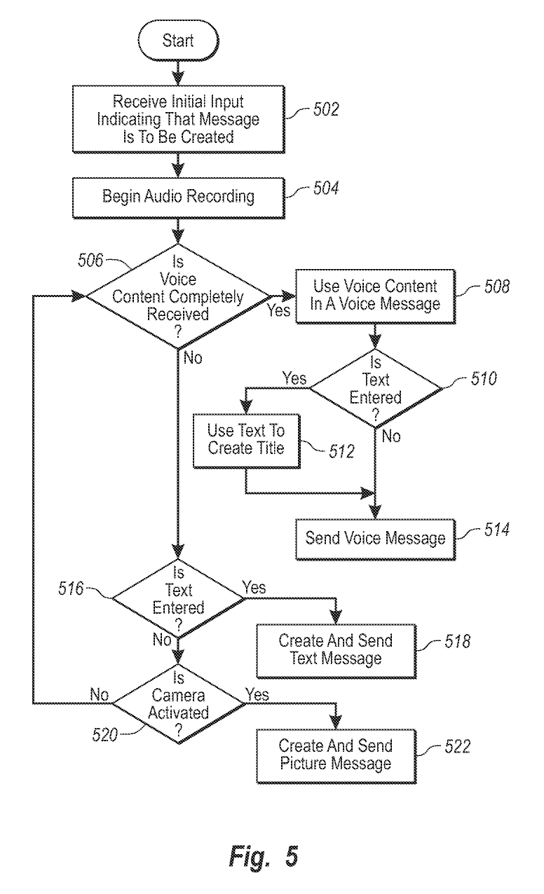

According to a second example illustrated in FIG. 5, the user provides input that indicates that the process of creating and sending a message is to begin (step 502). According to this example, the wireless communication device, in response to the user input, begins making an audio recording (step 504) of any voice content that is received after the user input. If the voice content is completely received (decision 506) the received voice content is used in a voice message (step 508). If the user enters text to the wireless communication device after the voice content is completely received and before the voice message is transmitted (decision 510), the entered text is used to create a title for the voice message (512). In either case, the wireless communication device then initiates transmission of the voice message (step 514).

If the user instead begins entering text to the wireless communication device before voice content is received or before a full amount of voice content is completely received (decision 516), the unified authoring interface of the invention recognizes the fact that text has been entered and initiates creation of and sends a text message that incorporates the entered text (step 518).

Optionally, this example can also extend to the use of a wireless device that has camera capabilities. In this case, the user can activate the camera shutter prior to completion of a voice message. If the wireless communication device detects activation of the camera shutter prior to the creation of a complete voice message (decision 520), the unified authoring interface of the invention initiates creation of a picture message using the picture that has been obtained by the wireless communication device. The wireless communication device then transmits the picture message to the recipient (step 522).

In addition, this example can also extend to the use of a wireless device that has video capabilities. In this case, the user can activate a video camera of the wireless device prior to completion of a voice message. If the wireless communication device detects activation of the video camera prior to the creation of a complete voice message, the unified authoring interface of the invention initiates creation of a video message using the video obtained by the wireless communication device. In response to user input (such as a selection of a “send video” soft key or other type of user input), the wireless communication device then transmits the video message to the recipient.

As these examples show, the decision of whether to send a voice message, a text message, or another type of message (e.g., a picture or video message) is made implicitly by the system based on the user actions. In this way, the system is simplified from traditional mobile phone message authoring solutions.

IV. Messages

As shown above, an authored message may be an audio message, a text message, a picture message, a video message, or other type of message. Exemplary audio messages may include, but are not limited to, voice messages (such as voicemail messages or VoiceSMS messages), and other audio messages. Exemplary text messages may include, but are not limited to, email messages, SMS messages, and other text messages.

### V. Invoking the Messaging Interface

As shown above, a messaging interface for authoring a message to a recipient may be invoked in response to user input. For example, in one instance discussed above with reference to FIG. 2, the recipient may be highlighted in a contact list and selection of the “Message” soft key 201 may invoke the messaging interface. In another example, the device 102 may have previously received a message—such as an audio message, a text message, a picture message, a video message, or other type of message—and the messaging interface may be invoked to author a message to a sender of the received message, in particular, to a reply-address of the received message. For instance, the received message may be highlighted in an inbox or the like, and the messaging interface may be invoked in response to the selection of a “Reply” button or soft key. The authored message may sent to the reply-address in response to user input, for instance, (as discussed above) when the “Send Voice” soft key 306 is pressed, when the “Send Text” soft key 406 is pressed, when the “send” key is pressed, when the “Reply” button, soft key or dedicated “Message” key is released, or in response to any other type of user input. Thus, the messaging interface may be used to author messages to various types of recipients, including, but not limited to, contacts from a contact list, senders of messages received by the device 102, or any other desired recipients.

### VI. Reply Addresses

In some embodiments, the device 102 may be configured to create a particular type of authored message based on the type of the authored message content and a reply address of a received message.

For example, where the reply address is a telephone number and the authored message content is audio, and the user presses the “Send Voice” soft key 306, presses the “send” key, or releases the “Reply” button, soft key or dedicated “Message” key, the device 102 may create a voice message (such as a VoiceSMS message, a voicemail message, or other voice message) that includes the audio content and send the voice message to the telephone number. But where the reply address is an email address, the authored message content is audio, and the user presses the “Send Voice” soft key 306, presses the “send” key, or releases the “Reply” button, dedicated “Message” key or soft key, the device 102 may create an audio file that includes the audio content, create an email, attach the audio file to the email, and send the email to the email address.

Also, for example, where the reply address is a telephone number, the authored message content is text, and the user presses the “Send Text” soft key 406, the device 102 may create a text message (such as an SMS message) that includes the text, and send the text message to the telephone number. But where the reply address is an email address, the authored message content is text, and the user presses the “Send Text” soft key 406, the device 102 may create an email that includes the text and send the email to the email address.

### VII. Audio-to-Text Translation

In some instances, the authored message content is audio, and the messaging interface may be configured to provide both the “Send Voice” soft key 306 and the “Send Text” soft key 406. In such instances, when the messaging interface is invoked, the device may commence receiving audio content and the messaging interface may provide both the “Send Voice” soft key 306 and the “Send Text” soft key 406.

If the user presses the “Send Voice” soft key 306, the device 102 may send the received audio content to the recipient. Where the authored message is to be sent to a telephone number (e.g., a selected or default telephone number of a contact in the contact list or a reply address of a previously received message), the device 102 may create a voice message (such as a VoiceSMS message, a voicemail message, or other voice message) that includes the audio content and send the voice message to the telephone number. Where the authored message is to be sent to an email address (e.g., a selected or default email address of a contact in the contact list or a reply address of a previously received message), the device 102 may create an audio file that includes the audio content, create an email, attach the audio file to the email, and send the email to the email address.

If the user presses the “Send Text” soft key 406, the device 102 may transcribe the received audio content to text and may send the text to the recipient. Where the authored message is to be sent to a telephone number (e.g., a selected or default telephone number of a contact in the contact list or a reply address of a previously received message), the device 102 may create a text message (such as an SMS message) that includes the text, and send the text message to the telephone number. Where the authored message is to be sent to an email address (e.g., a selected or default email address of a contact in the contact list or a reply address of a previously received message), the device 102 may create an email that includes the text and send the email to the email address.

In some embodiments, if the user presses the “Send Text” soft key 406, the device 102 may send the received audio content to a server that may transcribe the audio content into text and then send the text to the recipient. Where the authored message is to be sent to a telephone number (e.g., a selected or default telephone number of a contact in the contact list or a reply address of a previously received message), the server may create a text message (such as an SMS message) that includes the text, and send the text message to the telephone number. Where the authored message is to be sent to an email address (e.g., a selected or default email address of a contact in the contact list or a reply address of a previously received message), the server may create an email that includes the text and send the email to the email address. To facilitate this process, the device 102 may send the recipient's telephone number, email address, or other address contact information to the server.

### VIII. Telecommunication Devices and Computing Environments

Embodiments of the present invention may be implemented in connection with a special purpose or general purpose telecommunications device, including wireless telephones and other telephony-enabled mobile devices, personal digital assistants, laptop computers, or other mobile special purpose or general purpose computers that are adapted to have telecommunications or data networking capabilities. Embodiments within the scope of the present invention also include computer-readable media for carrying or having computer-executable instructions or electronic content structures stored thereon, and these terms are defined to extend to any such media or instructions that are used with telecommunications devices.

By way of example, and not limitation, such computer-readable media can comprise RAM, ROM, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

When information is transferred or provided over a network or another communications connection (either hardwired, wireless, or a combination of hardwired or wireless) to a computer or computing device, the computer or computing device properly views the connection as a computer-readable medium. Thus, any such a connection is properly termed a computer-readable medium. Combinations of the above should also be included within the scope of computer-readable media. Computer-executable instructions comprise, for example, instructions and content which cause a general purpose computer, special purpose computer, special purpose processing device or computing device to perform a certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

What is claimed is:

1. A wireless communication system comprising:
a handheld wireless communication device configured to:
commence receiving audio in response to first user input indicating an address;
present a plurality of user selectable options comprising:
a first user-selectable option; and
a second user-selectable option;
in response to a selection of the first user-selectable option, send the audio to the address indicated by the first user input; and
in response to a selection of the second user-selectable option, transcribe the audio into text and send the text to the address indicated by the first user input.

2. The wireless communication system as in claim 1, wherein the address indicated by the first user input comprises a reply address of a message received by the handheld wireless communication device.

3. The wireless communication system as in claim 2, wherein the message is a voicemail.

4. The wireless communication system as in claim 1, wherein the address indicated by the first user input comprises a telephone number.

5. The wireless communication system as in claim 1, wherein the address indicated by the first user input comprises a telephone number of a contact in a contact list.

6. The wireless communication system as in claim 1, wherein the address indicated by the first user input comprises an email address.

7. The wireless communication system as in claim 1, wherein the address indicated by the first user input comprises an email address of a contact in a contact list.

8. The wireless communication system as in claim 1, wherein the address indicated by the first user input comprises a telephone number; and wherein the handheld wireless communication device is configured to, in response to the selection of the first user-selectable option, send a voice message that includes the audio content to the telephone number.

9. The wireless communication system as in claim 8, wherein the telephone number is a reply address of a voice message received by the handheld wireless communication device.

10. The wireless communication system as in claim 1, wherein the address indicated by the first user input comprises a telephone number; and wherein the handheld wireless communication device is configured to, in response to the selection of the second user-selectable option after receiving the audio content, transcribe the audio content into text and send a text message that includes the text to the telephone number.

11. The wireless communication system as in claim 10, wherein the telephone number is a reply address of a voice message received by the handheld wireless communication device.

12. The wireless communication system as in claim 1, wherein the address indicated by the first user input comprises an email address; and wherein the handheld wireless communication device is configured to, in response to the selection of the first user-selectable option after receiving the audio content, send an email to the email address, the email including an audio file that includes the audio content.

13. The wireless communication system as in claim 1, wherein the address indicated by the first user input comprises an email address; and wherein the handheld wireless communication device is configured to, in response to the selection of the second user-selectable option after receiving the audio content, transcribe the audio content into text and send an email that includes the text to the email address.

14. A wireless communication system comprising:
a handheld wireless communication device configured to:
receive first user input indicating an address;
in response to the first user input, present a messaging user interface and to, when the messaging user interface is presented, automatically commence receiving audio content;
in response to receiving other-than-audio content while the audio content is being received, discard the audio content and create an other-than-audio message that includes the other-than-audio content; and
in response to receiving, while the audio content is being received, second user input indicating that an audio message should be sent, send an audio message that includes the received audio content to the address indicated by the first user input.

15. The wireless communication system as in claim 14, wherein the address indicated by the first user input comprises a reply address of a voice message received by the handheld wireless communication device.

16. The wireless communication system as in claim 15, wherein the reply address comprises a telephone number.

17. The wireless communication system as in claim 14, wherein the address indicated by the first user input comprises a telephone number of a contact in a contact list.

18. The wireless communication system as in claim 14, wherein the address indicated by the first user input comprises an email address of a contact in a contact list.

19. The wireless communication system as in claim 14, wherein the other-than-audio message is a text message.

20. The wireless communication system as in claim 14, wherein the other-than-audio content is text content.

21. The wireless communication system as in claim 14, wherein the other-than-audio message is a picture message.

22. The wireless communication system as in claim 14, wherein the other-than-audio content is picture content.

23. The wireless communication system as in claim 14, wherein the other-than-audio content is video content.
